(19) United States
(12) Patent Application Publication
(10) Pub. No.: US 2010/0127942 A1
(43) Pub. Date: May 27, 2010

(54) Weight-Tapered IL Antenna with Disc Loaded

(76) Inventors: Aviv SHACHAR, Ramat-Gan (IL); Yiu Kwong Chan, Vernon Hills, IL (US); Motti Elkobi, Natanya (IL)

Correspondence Address: MOTOROLA, INC., 1303 EAST ALGONQUIN ROAD, IL01/3RD, SCHAUMBURG, IL, 60196, US

(21) Appl. No.: 12/277,870

(22) Filed: Nov. 25, 2008

(51) Int. Cl. H01Q 9/04; H01Q 1/24

(52) U.S. Cl. 343/702; 343/700 MS

(57) ABSTRACT

An antenna includes a main span extending in a first direction, a first arm extending from the main span in a second direction, a second arm extending from the main span in a third direction; a disc portion joined to the main span.

### BACKGROUND

The capabilities of mobile communications devices are consistently increasing. Typical modern devices may require high levels of performance in transmitting and receiving wireless signals. However, devices may also be designed to minimize their size. Thus, antennas should be designed as to optimize performance in terms of bandwidth and radiation efficiency while minimizing their size.

### SUMMARY OF THE INVENTION

The present invention is directed to an antenna including a main span extending in a first direction, a first arm extending from the main span in a second direction, a second arm extending from the main span in a third direction, and a disc portion joined to the main span.

The present invention is further directed to a device including a wireless transceiver and an antenna coupled to the wireless transceiver. The antenna includes a main span extending in a first direction, a first arm extending from the main span in a second direction, a second arm extending from the main span in a third direction, and a disc portion joined to the main span.

### BRIEF DESCRIPTION OF THE DRAWINGS

FIG. 1 shows an exemplary mobile communication device according to the present invention.

FIG. 2 shows an exemplary antenna with a disc-shaped portion according to the present invention.

### DETAILED DESCRIPTION

The exemplary embodiments of the present invention may be further understood with reference to the following description and the appended drawings, wherein like elements are referred to with the same reference numerals. The exemplary embodiments describe antennas that improve bandwidth and radiation efficiency performance.

One important design concern in the development of modern mobile computing and communication devices is the reduction of space used by various components in order to minimize the overall size of devices. Like other components, it is desirable to reduce the space occupied by antennas without sacrificing performance. Commonly, inverted-L antennas may be used, but it may be desirable to improve the bandwidth and gain compared to such antennas. Other design concerns in antenna development include maximizing radiation efficiency in occupied bands and maintaining satisfactory performance when the distance between radiated elements decreases as the overall size of mobile devices decreases.

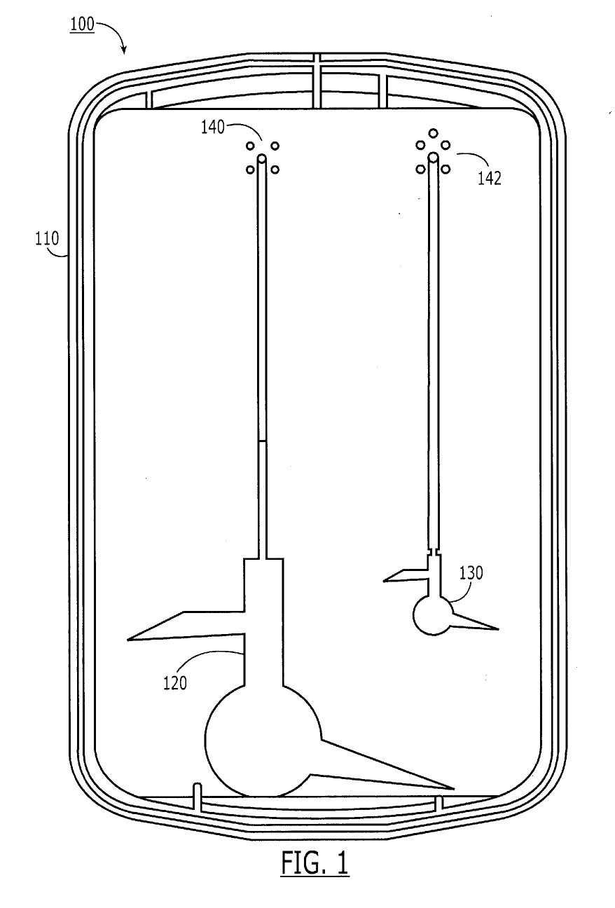

FIG. 1 illustrates an exemplary device 100 according to the present invention. The device 100 is shown with part of its casing 110 removed in order to illustrate internal components. The device 100 includes a first antenna 120 and a second antenna 130 that are disposed on a double-sided copper-plated substrate. In one exemplary embodiment, the substrate may be 0.762 mm thick with copper plating 0.0175 mm thick. The substrate may have a dielectric constant of 3.66 and a dissipation factor of 0.0035, and may be, for example, an RO4350B backing manufactured by the Rogers Company. The antennas 120 and 130 pass through the substrate via ports 140 and 142, respectively. Those of skill in the art will understand that each of the antennas 120 and 130 may be connected to a transceiver, not shown (e.g., a cellular transceiver, a Bluetooth transceiver, a WiFi transceiver, etc.). Further, those of skill in the art will understand that while this exemplary embodiment includes antennas 120 and 130 of substantially the same design and differing scale, various other devices may have a plurality of antennas that differ from one another in order to best suit the needs of various types of transceivers. For example, in another exemplary embodiment, the first antenna 120 may be substantially as described below, while the second antenna 130 may be a tapered-edge inverted L-type antenna.

Additionally, while the antennas 120 and 130 are depicted with the same orientation, other devices may orient antennas at an angle to one another in order to obtain better signal isolation. The first antenna 120 and the second antenna 130 share a common ground plane, but may have differing ground planes in other embodiments. The exemplary antennas 120 and 130 may be comprised of gold plating disposed on the copper substrate described above. In one exemplary embodiment, the plating may be a blend of nickel and gold with nickel plating of 0.003 mm thickness and gold plating of 0.00015 mm thickness. The leads of the antennas 120 and 130 may be spaced 35 mm apart on the substrate 140.

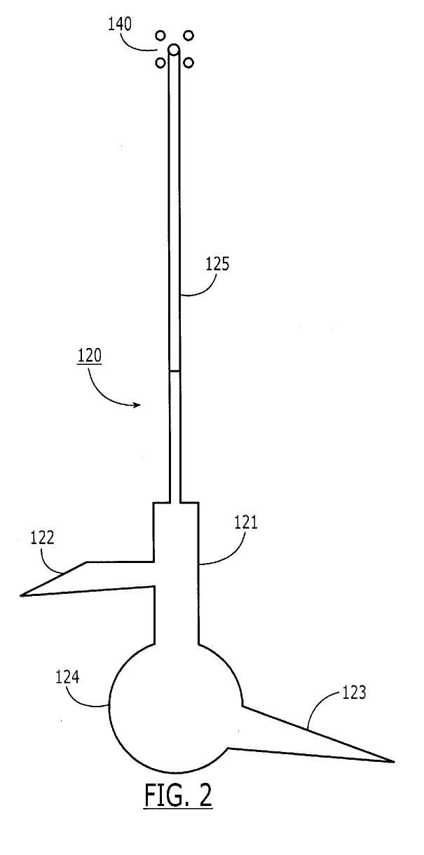

FIG. 2 shows the first antenna 120 in more detail. The first antenna 120 includes a main span 121, a first arm 122, a second arm 123, a disc-shaped portion (“disc”) 124, and a lead 125. The length of the main span 121 may be 37.64 mm from its intersection with the lead 125 to the center of the disc 124; its width may be 8.281 mm. The first arm 122 has a substantially tapered tip that is truncated near its base. The longest side of the first arm 122 may be 24.84 mm in length. The second arm 123 is also substantially tapered, and the longest side thereof may be 30.54 mm in length. Those of skill in the art will understand that the shapes of the arms 122 and 123 are only exemplary, and that other projection profiles may also be possible. The lead 125 may be 1.681 mm in width and may connect main span 121 to port 140.

The first antenna 120 further includes a disc-shaped portion 124. The disc 124 is centered substantially at the intersection of the main span 121 and the second arm 123, and may have a radius of 12 mm. It may abut the casing 110 of the device 100. The disc 124 may hold charges and thus enhance the sending/receiving properties of the main span 120 of the first antenna 120, such as the bandwidth impedance, particularly in higher bands. This enhancement may be accompanied by a minor decrease in efficiency. Those of skill in the art will understand that the dimensions described above are only exemplary and that the dimensions of other exemplary embodiments may vary from those provided.

The first antenna 120 may be used, for example, with a transceiver in the cellular band (e.g., AMPS, GSM, DCS, PCS, UMTS, etc.). In such frequencies, it may achieve a bandwidth of 23%, a significant improvement of the bandwidth range of 5% to 12% typically achieved by monopole or dipole antennas. As discussed above, in this exemplary embodiment, the second antenna 130 may be similar to the first antenna 120 but of smaller scale. The scale may be one-third in this exemplary embodiment but may vary in other embodiments. The second antenna 130 may be used, for example, with a WiFi (e.g., 802.11a/b/g) transceiver. Like the first antenna 120, the second antenna may achieve a bandwidth of 23%, a significant improvement over typical monopole/dipole antennas.

Both the first antenna 120 and the second antenna 130 may have omni-directional radiation patterns. At the ports 140 and 142, the voltage standing wave ratio may be less than 1:2.5 across the entire band. The first antenna 120 may achieve an efficiency of at least 80% in the AMPS and GSM frequency bands, 70% in the DCS and PCS frequency bands, and 60% in the UMTS frequency band. The second antenna 130 may achieve an efficiency of at least 90% in the WiFi 802.1b/g bands and at least 55% in the WiFi 802.11a band.

It will be apparent to those skilled in the art that various modifications may be made in the present invention, without departing from the spirit or the scope of the invention. For example, the principles described may be applied to antennas adapted to send and receive signals in various frequency bands and for various purposes. Thus, it is intended that the present invention cover modifications and variations of this invention provided they come within the scope of the appended claims and their equivalents.

What is claimed is:

1. An antenna, comprising:
a main span extending in a first direction;
a first arm extending from the main span in a second direction;
a second arm extending from the main span in a third direction; and
a disc portion joined to the main span.

2. The antenna of claim 1, wherein the first arm and the second arm are substantially tapered.

3. The antenna of claim 2, wherein the first arm is a truncated taper.

4. The antenna of claim 1, wherein the disc portion has a center substantially disposed at an intersection of the main span and the second arm.

5. The antenna of claim 1, wherein the second direction is substantially perpendicular to the first direction.

6. The antenna of claim 5, wherein the third direction is substantially opposite the second direction.

7. A device, comprising:
a wireless transceiver; and
an antenna coupled to the wireless transceiver, the antenna including:
a main span extending in a first direction;
a first arm extending from the main span in a second direction;
a second arm extending from the main span in a third direction; and
a disc portion joined to the main span.

8. The device of claim 7, wherein the first arm and the second arm are substantially tapered.

9. The device of claim 8, wherein the first arm is a truncated taper.

10. The device of claim 7, wherein the disc portion has a center substantially disposed at an intersection of the main span and the second arm.

11. The device of claim 7, wherein the second direction is substantially perpendicular to the first direction.

12. The device of claim 11, wherein the third direction is substantially opposite the second direction.

13. The device of claim 7, wherein the wireless transceiver is a cellular transceiver.

14. The device of claim 7, further comprising:
a further wireless transceiver; and
a further antenna coupled to the further wireless transceiver.

15. The device of claim 14, wherein the further antenna has a profile substantially similar to a profile of the antenna.

16. The device of claim 15, wherein a scale of the further antenna is smaller than a scale of the antenna.

17. The device of claim 16, wherein a main span of the further antenna extends in the first direction.

18. The device of claim 14, wherein the further antenna has a profile substantially different from a profile of the antenna.

19. The device of claim 14, wherein the antenna and the further antenna share a ground plane.

20. The device of claim 14, wherein the further wireless transceiver is a WiFi transceiver.
